(19) United States
(12) Patent Application Publication
(10) Pub. No.: US 2026/0294731 A1
(43) Pub. Date: Oct. 1, 2026

(54) SEXUAL AID

(71) Applicant: Jessie Nelson, Duluth, MN (US)

(72) Inventor: Jessie Nelson, Duluth, MN (US)

(21) Appl. No.: 19/095,436

(22) Filed: Mar. 31, 2025

(51) Int. Cl. A61H 19/00

(52) U.S. Cl. CPC A61H 19/32; A61H 2201/1642; A61H 2201/165; A61H 2205/087

(57) ABSTRACT

A two-foot enclosure device, or sexual aid, enhances a foot masturbation experience for both a wearer and an inserting user. The sexual aid includes a foot sleeve configured to hold portions of a wearer's two feet together within an internal space of the foot sleeve. A securing feature extends from the foot sleeve and retains the sexual aid to the wearer's feet. The securing feature may define a loop to wrap behind the wearer's feet and then up and over the wearer's toes. In certain examples, the foot sleeve and securing feature are formed out of an elastic silicone material and undersized when compared to the wearer's feet. In this way, when worn, the foot sleeve and securing feature are in a partially or fully stretched position and the wearer's feet are biased towards one another by the sexual aid.

### BACKGROUND

Sexual aids have been used to enhance and alter the sexual experience of users and partners. As technology and sexual interests evolve, there is a continued need for advancements in sexual aids.

### SUMMARY

In general terms, this disclosure is directed to a sexual aid. In some embodiments, and by non-limiting example, the sexual aid is a two-foot enclosure device with a first open end and a second open end. An internal space is disposed between the first open end and the second open end, and the internal space is configured to receive portions of two feet. The two-foot enclosure device also has a securing feature that is configured to extend from the first open end of the foot sleeve. The securing feature is configured to wrap around at least part of the two-foot enclosure device.

In other embodiments, the sexual aid for feet is a sexual aid with first and second open ends. The sexual aid has a foot sleeve that is sized to accommodate at least a forward portion of both feet of a wearer. The sexual aid also has a securing feature that is connected to the foot sleeve. The securing feature is configured to secure the sexual aid to the wearer's feet.

In other embodiments, the sexual aid for feet is a sexual aid with a foot sleeve. The foot sleeve has a first open end and a second open end. An internal space is defined by the foot sleeve and disposed between the first and second open ends. The internal space is configured to receive portions of a wearer's two feet such that a portion of the wearer's feet extend past the second open end. The internal space is also configured to receive at least a portion of a user's penis. The sexual aid has a loop that is integrally formed with the foot sleeve. The loop extends from the first open end of the foot sleeve and is configured to wrap around back portions of the wearer's feet, over the wearer's toes, and around the foot sleeve.

### BRIEF DESCRIPTION OF THE DRAWINGS

FIG. 1 is a front perspective view of a sexual aid, in accordance with the principles of the present disclosure.

FIG. 2 is a back perspective view of the sexual aid of FIG. 1.

FIG. 3 is a front view of two feet held in an internal space of a sexual aid, in accordance with the principles of the present disclosure.

FIG. 4 is a front perspective view of two feet held in an internal space of a sexual aid and a strap partially wrapping around the two feet, in accordance with the principles of the present disclosure.

FIG. 5 is a front view of two feet held in an internal space of a sexual aid and secured by a securing feature, in accordance with the principles of the present disclosure.

FIG. 6 is a back view of the sexual aid of FIG. 5.

FIG. 7 is a front view of two feet held together by a sexual aid with a penis being inserted along a central axis, in accordance with the principles of the present disclosure.

FIG. 8 is a side perspective view of two feet held together by a sexual aid with a penis being inserted orthogonal to a central axis, in accordance with the principles of the present disclosure.

FIG. 9 is a front perspective view of another example sexual aid, in accordance with the principles of the present disclosure.

FIG. 10 is a front perspective view of another example sexual aid, in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Sexual partners may enjoy “foot play”, which generally includes masturbating a partner with one's feet. A type of foot play can include “foot jobs”. Foot jobs generally entail one partner holding the soles of their feet together, while the other partner inserts their penis between the feet.

However, partners engaging in foot jobs may face several difficulties. First, the person holding their feet together may not have the required dexterity in their feet for an adequate experience, especially for a novice foot masturbator. Also, holding such a position for an extended period of time may be strenuous for the partner, causing muscle exhaustion and potential cramps, which can hinder their experience and require breaks. Further, the person holding the position may not be able to hold the soles of their feet together with the pressure desired by their partner.

The present disclosure generally relates to a two-foot enclosure device, (also referred to as a sexual aid) to enhance the foot job experience for both the wearer of the device and the wearer's partner, the user. The sexual aid fits portions of two feet within an internal space to retain the soles of the two feet against one another. The sexual aid utilizes a securing feature to secure the feet within the internal space.

By securely holding the feet together and reducing or eliminating the need for dexterity, the sexual aid allows even novice couples to practice foot jobs. Further, the sexual aid relieves the stress on muscles that would otherwise be required to hold the feet together, which allows for a more comfortable, and if desired, longer experience. The sexual aid may also allow the soles of the feet to be pressed more firmly against one another, which may be desired by the inserting user. Further still, the two-foot enclosure device allows for these exemplary benefits without the need of hand-assistance. As such, the wearer may use their hands to rest in a more comfortable posture, among other things.

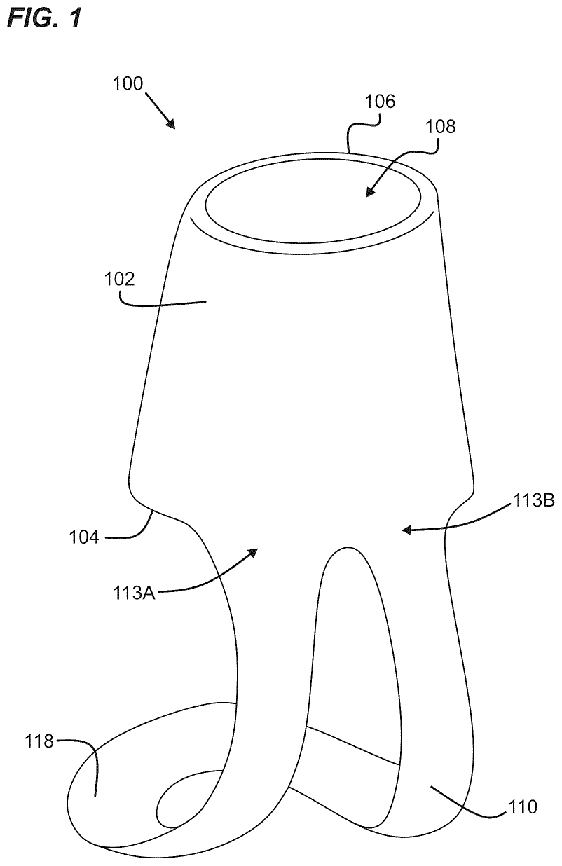

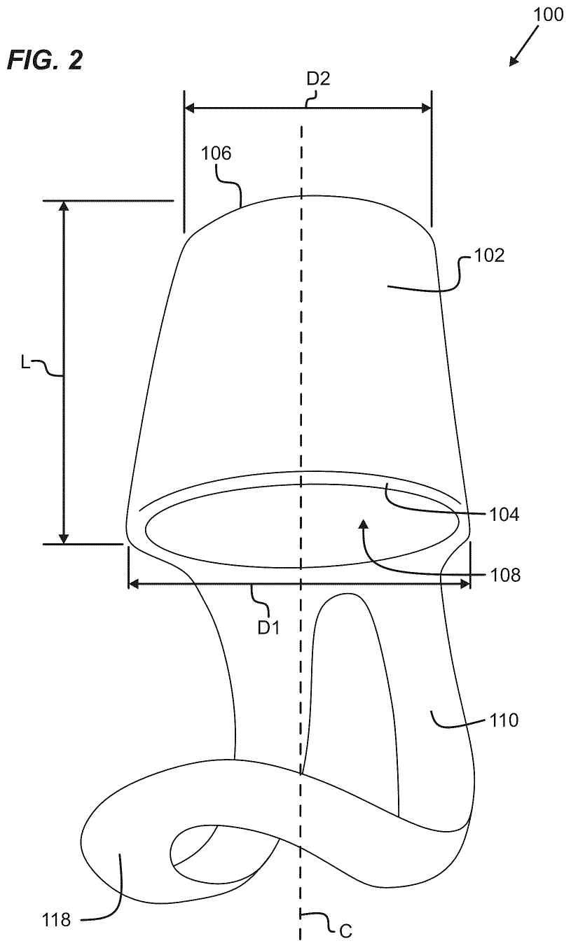

Referring to FIGS. 1 and 2, a sexual aid 100 is shown, according to a certain example. It is to be appreciated that the sexual aid 100 may also be referred to as a two-foot enclosure device 100 throughout this disclosure, and the terms are intended to be used interchangeably. Further, for the sake of clarity, “wearer” is used to refer to the person wearing the sexual aid and “user” refers to the person inserting their penis between the feet of the wearer. The wearer and user are collectively referred to as a “couple”.

The sexual aid 100 includes a foot sleeve 102 designed to fit around portions of the wearer's feet 112A and 112B. The foot sleeve 102 has a first open end 104 and a second open end 106 opposite from the first open end 104. The first open end 104 and second open end 106 are spaced a length L away from one another. The foot sleeve 102 defines an internal space 108 that is designed to fit portions of the wearer's feet 112A and 112B within it. The internal space 108 is disposed between the first open end 104 and the second open end 106. Further, the foot sleeve 102 surrounds a central axis C. The central axis C extends through the center of the first open end 104 and the second open end 106.

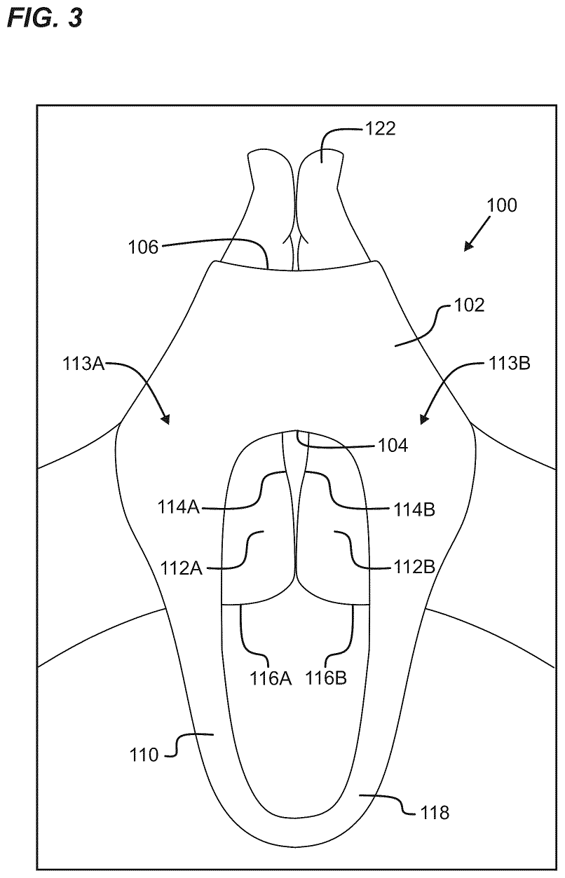

In certain examples, the foot sleeve 102 defines a frustoconical tubular shape, as shown in the figures. Such a shape may be advantageous, for example, to create an improved anatomical fit around two feet, when the sole of each foot is pressed together (shown in FIG. 3-8). An improved anatomical fit may be more comfortable for the wearer, and it also may be easier for the wearer to insert their feet 112A and 112B into the internal space 108. In certain examples, the first open end 104 defines a first opening perimeter with a first diameter D1 and the second open end 106 defines a second opening perimeter with a second diameter D2. In certain examples, the second opening perimeter and second diameter D2 may be between ½ and ¾ the size of the first opening perimeter and first diameter D1. In certain examples, the first diameter D1 of the first opening perimeter may be between ½ and ¾ the distance of length L. However, in other examples, the foot sleeve 102 can define a substantially cylindrical tubular shape, such that the first opening perimeter and first diameter D1 are substantially the same size as the second opening perimeter and second diameter D2. In certain examples, the first diameter D1 and second diameter D2 are both between ½ and ¾ the length L. A cylindrical shape may be desirable, for example, for ease of manufacturing or personal user preference. As shown, the foot sleeve 102 defines a continuous surface. However, in other examples, the foot sleeve 102 can define one or more openings. In certain examples, the foot sleeve 102 can also define a slot extending from the first open end 104 towards the second open end 106. An opening or slot may be advantageous, for example, for ventilation, injection of lubricant, or to provide an additional insertion location for a user.

The sexual aid 100 further includes a securing feature 110, designed to retain the foot sleeve 102 on the wearer's feet 112A and 112B during use. The securing feature 110 is configured to extend from the first open end 104 of the foot sleeve 102. In certain examples, as shown in the figures, the securing feature 110 extends from first and second securing regions 113A and 113B of the first open end 104. In certain examples, the first and second securing regions 113A and 113B are spaced apart about the first opening perimeter by between ¼ and ⅓ of the first opening perimeter or between ½ and a full first diameter D1. In another example, the first and second securing regions 113A and 113B are spaced apart about the first opening perimeter by between ⅓ and ½ of the first opening perimeter. In the example shown in the figures, the securing feature 110 is formed by a foot strap, where the foot strap forms a loop 118 between the first and second securing regions 113A and 113B. In the example shown in the figures, the first and second securing regions 113A and 113B are separated by approximately ¼ of the first opening perimeter or by approximately ½ of the first diameter D1, measured from center to center of the first and second securing regions 113A and 113B. In certain examples, the securing feature 110 extends from a single securing region. For example, the loop 118 can extend from the foot sleeve 102 in a single location.

As shown, the securing feature 110 and foot sleeve 102 are formed together such that the sexual aid 100 is an integrally formed, single piece. However, in other examples, the securing feature 110 and foot sleeve 102 are two separate pieces. In a two-piece implementation, the securing feature 110 can be attached to the foot sleeve 102, for example, via snaps, buckles, hook and loop fasteners, ratchet mechanisms, or other attachment means generally known in the art. An exemplary advantage of a two-piece implementation is that the securing feature 110 can be attached to the foot sleeve 102 at different locations on the foot sleeve 102 or securing feature 110. Adjustable attachment locations may be advantageous so that the size and tightness of the securing feature 110 can be adjusted based on wearer and/or user preference.

In a certain example, the foot sleeve 102 and securing feature 110 are formed from an elastic material, which provides an exemplary advantage of biasing a wearer's feet towards one another (as discussed in further detail below). For example, a silicone material can be cast or injection molded to make an integrally formed, single-piece sexual aid 100 with elasticity. An exemplary advantage of silicone is that it is easy to clean, allowing for hygienic use of the sexual aid. Further exemplary advantages of silicone include that it is body-safe and non-toxic, hypoallergenic, durable, temperature-responsive, and non-reactive with types of lubricants that are commonly used for sexual activities.

However, other materials may be used, such as natural or synthetic fibers, or a combination thereof. Natural fiber materials can include, for example, cotton, linen, hemp, bamboo, wool, or silk. Synthetic fibers can include, for example, polyester, nylon, or spandex. In certain examples, the foot sleeve 102 and securing feature 110 are made from a body-safe material that can be easily cleaned. Further, an exemplary material is non-reactive and compatible with types of lubricants commonly used for sexual activities. In a certain example, the foot sleeve 102 and securing feature 110 are made from the same material (or same combination of materials), but in other examples, the foot sleeve 102 and securing feature 110 may be made of different materials (or combinations of materials).

In certain examples, the foot sleeve 102 has a wall thickness that is equal to a wall thickness of the securing feature 110. In other examples, the securing feature 110 may have a wall thickness that is lesser than the wall thickness of the foot sleeve 102. In certain examples, the securing feature 110 may have a wall thickness that is ¼ to ¾ the wall thickness of the foot sleeve 102. In certain examples where the sexual aid 100 is a single, integrally formed piece, and the securing feature 110 defines a loop 118, the loop 118 and foot sleeve 102 have an equal wall thickness at the first and second securing regions 113A and 113B and throughout the entire loop 118. In other examples, the loop 118 and foot sleeve 102 have an equal wall thickness at the first and second securing regions 113A and 113B, and the loop 118 has a decreasing tapered wall thickness as it extends away from the foot sleeve 102, where it may reach a minimum wall thickness of ¼ to ¾ the wall thickness of the foot sleeve 102. Such an example may be advantageous in implementations where the securing feature 110 is elastic, for example, to allow the securing feature 110 to stretch more and with less force to enable the securing feature 110 to easily be pulled around the wearer's feet 112A and 112B.

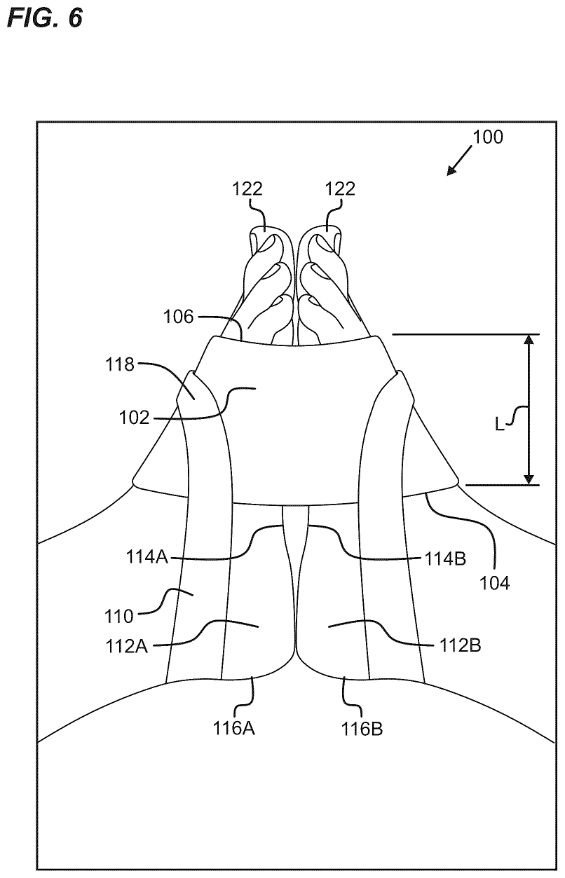

Referring now to FIGS. 3-6, a sexual aid 100 is shown being worn by a wearer. In use, a wearer positions their feet 112A and 112B together such that soles 114A and 114B of the feet are pressed against one another. The foot sleeve 102 is placed around the feet 112A and 112B such that forward portions of the feet 112A and 112B enter the internal space 108 of the foot sleeve 102 through the first open end 104. As shown in FIG. 6, the foot sleeve 102 extends a length L, leaving a portion of the feet 112A and 112B exposed. In certain examples, length L may be longer such that more or substantially all of the feet 112A and 112B are covered by the foot sleeve 102. In other examples, length L may be shorter such that less of the feet 112A and 112B are covered by the foot sleeve 102 and more of the wearer's feet 112A and 112B are exposed. In certain examples, length L is long enough to cover all or substantially all of the feet 112A and 112B, but the length L is adjustable (for example, by rolling or folding the foot sleeve 102 back onto itself), such that the wearer can adjust how much of their feet 112A and 112B are exposed. Different lengths L may be desired, for example, because the wearer and or user may want pressure from the foot sleeve 102 spread across certain areas of the feet 112A and 112B.

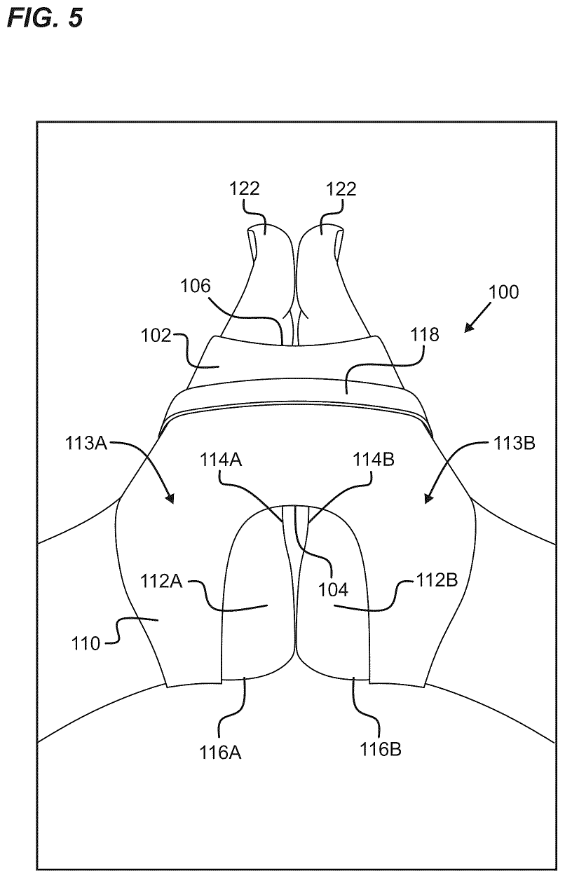

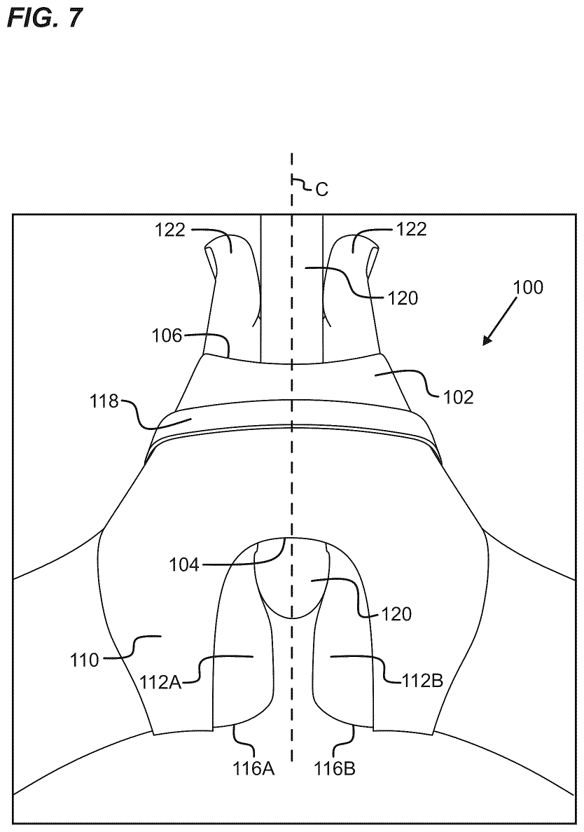

In certain examples where the foot sleeve 102 is made of an elastic material, the internal space 108 may be undersized when compared to the feet 112A and 112B. In these examples, the foot sleeve 102 and securing feature 110 rest in an unstretched position when not on a wearer's feet 112A and 112B, as shown in FIGS. 1-2. An undersized internal space 108 allows for the foot sleeve 102 to receive the feet 112A and 112B in a partially stretched position, as shown in FIG. 5. As such, the foot sleeve 102 provides a pressure or force to hold the feet 112A and 112B together, which can relieve muscle stress for the wearer and enhance the experience for both the wearer and the user. In these examples, the elasticity, size, and/or wall thickness of the foot sleeve 102 can be chosen based off the size of the wearer's feet 112A, 112B, the desired tightness of the fit for the wearer, and/or the desired pressure of the user. When a penis is inserted between the wearer's feet 112A and 112B, the foot sleeve 102 can stretch further to a fully stretched position, as shown in FIG. 7, to accommodate the user's penis.

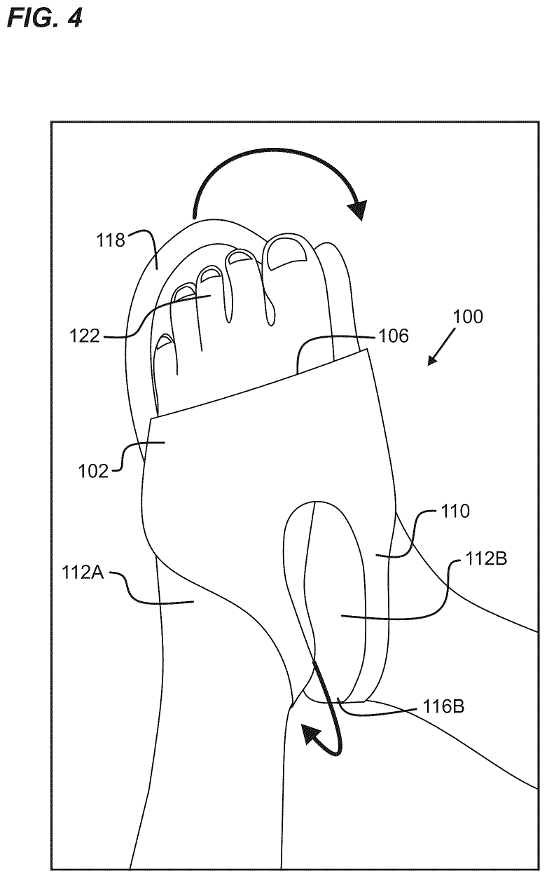

As shown in FIG. 3, the securing feature 110 is positioned on the inside of the wearer's feet 112A and 112B. However, the securing feature 110 could also be positioned on the outside of the wearer's feet 112A and 112B. As shown in FIG. 4, the securing feature 110 is then wrapped around back portions 116A and 116B of the wearer's feet 112A and 112B. As shown, the back portions 116A and 116B include the wearer's Achilles. In other examples, the back portions 116A and 116B include the back of the heel and/or part of the ankle as well.

As shown in FIGS. 5 and 6, once the securing feature 110 is wrapped around the back portions 116A and 116B of the wearer's feet, the securing feature 110 is then secured to the sexual aid 100. In this manner, the feet 112A, 112B are held together by the foot sleeve 102, and the foot sleeve 102 is secured to the feet 112A, 112B by the securing feature 110. As shown, in a certain example, the securing feature 110 includes a loop 118 and is secured to the sexual aid 100 by wrapping the loop 118 over the second open end 106 and around the foot sleeve 102. In examples where the securing feature 110 is made of an elastic material, the loop 118 can also be undersized compared to the feet 112A, 112B. In this way, the loop 118 can also receive portions of the wearer's two feet 112A and 112B in a partially stretched position, and then further stretch to a fully stretched position to accommodate a penis. Accordingly, the loop 118 can provide an additional force to hold the feet 112A, 112B together once the loop 118 is wrapped around the foot sleeve 102. The loop 118 could also be sized according to the wearer's feet 112A, 112B, elasticity of the material, and desired tightness by the wearer and inserting user. An exemplary advantage of the loop 118 is the ease of use. A wearer can easily grasp the loop 118, pull it around the back portions 116A and 116B of their feet 112A and 112B and around the foot sleeve 102 with one hand and in a single motion. In a similar operation, it would be easy for a wearer to secure the sexual aid 100 to the wearer.

In other examples, the securing feature 110 can include two straps (not shown). Like previously described, in use, once the foot sleeve 102 is placed over the wearer's feet 112A and 112B, the straps are wrapped around the back portions 116A and 116B of the wearer's feet and around the foot sleeve 102. The straps can then be secured to one another, essentially creating the loop 118, as previously described. Alternatively, both straps can be configured to wrap over the foot sleeve 102 in the front ankle portion of the foot and be secured back to each respective strap. In this way, each strap creates a loop around one of the wearer's ankles. Alternatively, the straps could be configured to wrap around the back portions 116A and 116B of the wearer's feet 112A and 112B, around the foot sleeve 102, and be secured to the opposite strap. In this way, the straps would create a substantially X-shaped pattern in the view of FIG. 5. Such an arrangement could provide additional support and pressure for the wearer. In certain examples, the straps could extend behind the back portions 116A and 116B of the wearer's feet 112A and 112B and be secured to second open end 106, which could best be visualized with reference to FIG. 6. The straps could be secured by snaps, buttons, hook and loop fasteners, ratchet mechanisms, or any other method of attachment generally known. An exemplary advantage of a strap implementation is that it could allow the user to adjust the fit of the sexual aid 100 by tightening or loosening the straps.

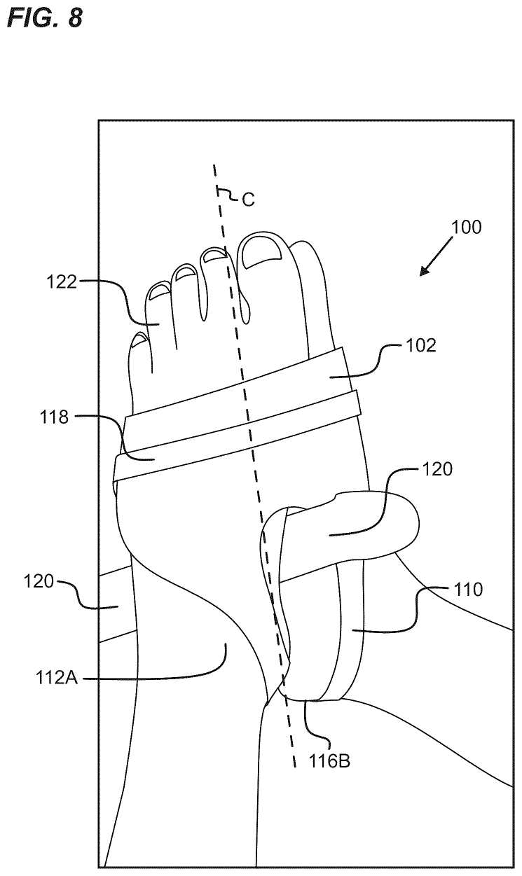

Referring now to FIGS. 7 and 8, the sexual aid 100 is shown in use. Once the wearer is wearing the sexual aid 100, the user can insert their penis 120 between the wearer's feet 112A and 112B. As shown in FIG. 7, one option for the user is to insert their penis 120 between the wearer's feet 112A, 112B, starting at the wearer's toes 122 and continuing toward, or through, the second open end 106, along the central axis C. As shown in FIG. 8, the user can also insert their penis between the wearer's feet 112A and 112B in a direction orthogonal to the central axis C.

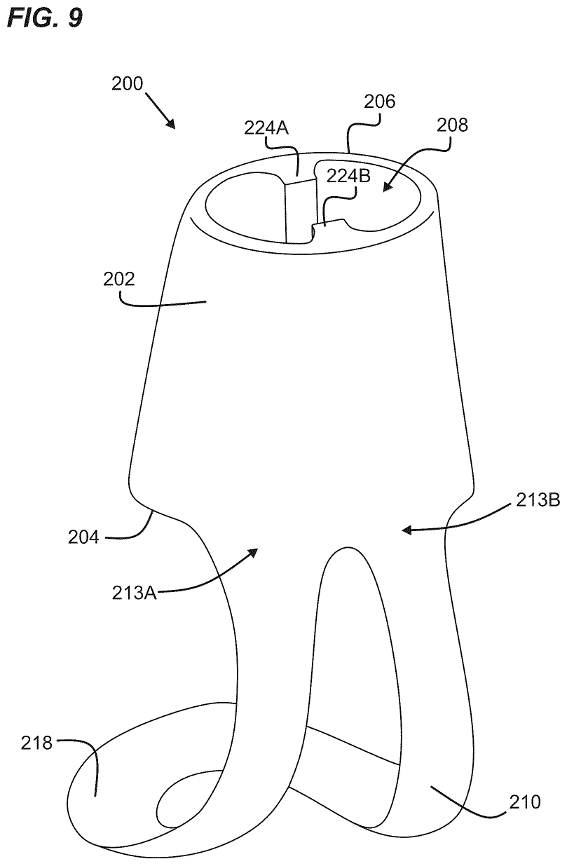

Referring now to FIG. 9, a sexual aid 200 is shown, according to a certain example. Sexual aid 200 is substantially similar to sexual aid 100 previously described in various examples. Accordingly, similar reference numerals of sexual aid 200 correspond to similar reference numerals of sexual aid 100, i.e. foot sleeve 202 corresponds to foot sleeve 102. Unless indicated otherwise, all the examples, variations, features, and exemplary advantages discussed with reference to FIGS. 1-8 are applicable to sexual aid 200 and its corresponding elements.

Sexual aid 200 further includes a stabilizing feature configured to maintain the penis in proper alignment between the feet. In certain examples, the stabilizing feature is configured to keep the penis aligned with the central axis. In certain examples, the stabilizing feature includes a first ridge 224A and a second ridge 224B. The first and second ridge 224A and 224B extend from the foot sleeve 202 into the internal space 208. The first and second ridge 224A and 224B are disposed on opposite sides of the second open end 206.

In certain examples, the first and second ridge 224A and 224B each extend into the internal space 208 ⅛ to ⅜ the diameter of the second open end 206. In certain examples, the first and second ridge 224A and 224B continuously span the entire length of the foot sleeve 202. In certain examples, the first and second ridge 224A and 224B span ½ to ¾ the length of the foot sleeve 202. In certain examples, the first and second ridge 224A and 224B define a non-planar, or otherwise discontinuous surface. In certain examples, the first and second ridge 224A and 224B extend a non-constant distance into the internal space 208 along the length of the foot sleeve 202. In this example, the first and second ridge 224A and 224B can be configured to maintain a constant distance between them when implemented in a frustoconical tubular foot sleeve 202, providing constant stabilization of the penis along the length of the foot sleeve 202. The first and second ridge 224A and 224B may also increase the comfort of the wearer, by partially splitting the internal space 208 into two separate spaces, which can each accommodate a foot.

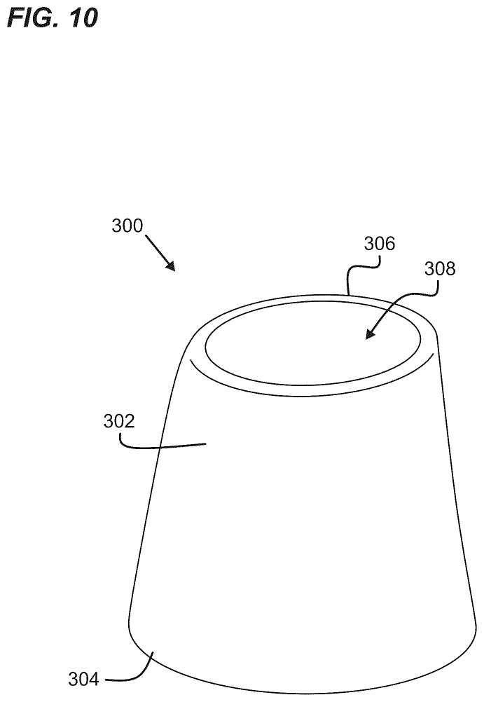

Referring now to FIG. 10, a sexual aid 300 is shown, according to a certain example. Sexual aid 300 is substantially similar to sexual aid 100 and 200 previously described in various examples. Accordingly, similar reference numerals of sexual aid 300 correspond to similar reference numerals of sexual aid 100 and 200, i.e. foot sleeve 302 corresponds to foot sleeve 102 and 202. Unless indicated otherwise, all the examples, variations, features, and exemplary advantages discussed with reference to FIGS. 1-9 are applicable to sexual aid 300 and its corresponding elements.

Sexual aid 300 includes a single part configured to hold the wearer's feet together. In certain examples, sexual aid 300 includes a foot sleeve 302. In these examples, foot sleeve 302 is configured to retain the sexual aid 300 to the wearer's feet without the need for a securing feature. In certain examples, the friction between the wearer's feet and the foot sleeve 302 is sufficient to retain the foot sleeve to the wearer's feet. In certain examples, the foot sleeve 302 material has sufficient elasticity to retain the foot sleeve to the wearer's feet. Such an example may be advantageous, for example, for a wearer to more quickly and easily put on the sexual aid 300.

In certain examples, a method of attaching the sexual aid to the wearer's feet includes the following steps: the first step includes positioning the foot sleeve 102 around the wearer's feet 112A and 112B. The second step includes orienting the securing feature 110 around back portions 116A and 116B of the wearer's feet 112A and 112B. The third step includes securing the securing feature 110 to the sexual aid 100.

In certain examples, positioning the foot sleeve 102 around the wearer's feet 112A, 112B includes the wearer pressing their soles 114A and 114B together and pulling the foot sleeve 102 over their feet 112A and 112B with their hands, while the feet 112A and 112B remain stationary. In other examples, the wearer may hold sexual aid 100 stationary while moving their feet 112A and 112B into the internal space 108 of the foot sleeve 102, or there may be a combination of moving both the foot sleeve 102 and the feet 112A and 112B. In some examples, positioning the foot sleeve 102 around the wearer's feet 112A and 112B is accomplished by, or with the help, of the user. In certain examples, the foot sleeve 102 is positioned around the wearer's feet 112A and 112B such that the securing feature 110 faces the wearer. In other examples, the foot sleeve 102 is positioned around the wearer's feet 112A and 112B such that the securing feature 110 faces away from the wearer.

In certain examples, orienting the securing feature 110 around back portions 116A, 116B of the wearer's feet 112A, 112B includes pulling the securing feature 110 away from the wearer, as shown in FIG. 4. In other examples, where the securing feature 110 faces away from the wearer, the securing feature 110 is oriented around back portions 116A and 116B by pulling the securing feature 110 towards the wearer. In certain examples, the wearer orients the securing feature 110 around back portions 116A and 116B of their own feet 112A and 112B. In other examples, the user orients the securing feature 110 around back portions 116A and 116B of the wearer's feet 112A and 112B.

In certain examples where the securing feature 110 includes a loop 118, securing the loop 118 to the sexual aid 100 includes wrapping the loop 118 over and around the foot sleeve 102 and feet 112A and 112B, as shown in FIGS. 4-5. In certain examples where the securing feature 110 includes two straps, securing the securing feature 110 to the sexual aid 100 includes one or more of the exemplary steps of: wrapping the straps around the foot sleeve 102 and securing the straps to one another in a loop, wrapping the straps around the ankles of the wearer securing each strap back to itself, or wrapping the straps around the ankles of the wearer and across the foot sleeve 102 to secure near the opposite back portions 116A and 116B to generally create an X shape in the view of FIG. 5.

In certain examples where the securing feature 110 is not integrally formed with the foot sleeve 102, there is an additional step of attaching the securing feature 110 to the foot sleeve 102. In certain examples, this can include buckling, snapping, tying, fastening, ratcheting, or otherwise connecting the two pieces together, depending on the chosen attachment mechanism. In certain examples, the securing feature 110 is attached to the foot sleeve 102 as the first step. In certain examples, the securing feature 110 is first secured to the foot sleeve 102, then oriented around back portions 116A and 116B of the wearer's feet, and then attached to the sexual aid 100. To illustrate the difference, in examples where the securing feature 110 is a loop 118, the loop 118 could either be attached to the foot sleeve 102 and then wrapped around the feet 112A and 112B, or wrapped around the feet 112A and 112B and then attached to the foot sleeve 102.

In certain examples, a method of using the sexual aid includes the following steps: the first step includes attaching the sexual aid 100 to the wearer's feet 112A and 112B, as previously discussed. The second step includes inserting a user's penis 120 between the wearer's feet 112A and 112B.

In certain examples, inserting a user's penis 120 includes inserting along the central axis C, between the wearer's toes 122. In certain examples, the penis 120 is inserted orthogonal to the central axis C, between the arches of the wearer's feet 112A and 112B. In certain examples, another step includes lubricating the feet 112A and 112B and/or penis 120 with lubricants commonly used for sexual activities. In certain examples, lubricating can be done before inserting the user's penis 120. In other examples, lubricating can be done after or during insertion, for example, through the first or second open ends 104 and 106 or through additional slots or openings defined by the foot sleeve 102.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A two-foot enclosure device comprising:
a foot sleeve, the foot sleeve having a first open end and a second open end, an internal space defined by the foot sleeve, the internal space being between the first and second ends, the internal space being configured to receive portions of two feet; and
a securing feature configured to extend from the first open end, the securing feature being configured to wrap around at least part of the foot sleeve.

2. The two-foot enclosure device of claim 1, wherein the foot sleeve and the securing feature are integrally formed.

3. The two-foot enclosure device of claim 2, wherein the securing feature defines a loop.

4. The two-foot enclosure device of claim 1, wherein at least one of the foot sleeve or the securing feature is configured to receive portions of the two feet in a partially stretched position.

5. The two-foot enclosure device of claim 1, wherein the foot sleeve generally defines a frustoconical shape.

6. The two-foot enclosure device of claim 1, wherein the securing feature is removable from the foot sleeve.

7. The two-foot enclosure device of claim 1, wherein the securing feature is adjustable.

8. The two-foot enclosure device of claim 1, wherein the foot sleeve further defines at least one opening or slot.

9. The two-foot enclosure device of claim 1, wherein the internal space is further configured to receive a penis inserted along a central axis of the foot sleeve.

10. A sexual aid comprising:
a foot sleeve having first and second open ends, the foot sleeve sized to accommodate at least a forward portion of both feet of a wearer, the foot sleeve being stretchable to receive a penis between the wearer's feet at the second open end.

11. The sexual aid of claim 10, further comprising a securing feature connected to the foot sleeve, the securing feature configured to secure the sexual aid to the wearer's feet.

12. The sexual aid of claim 11, wherein the sexual aid is configured to receive the penis orthogonal to a central axis.

13. The sexual aid of claim 11, wherein the securing feature defines a loop extending from the first open end of the foot sleeve, wherein the loop is wrappable around back portions of both feet and over toes of both feet such that the sexual aid is secured to both feet.

14. The sexual aid of claim 11, wherein the foot sleeve and the securing feature are integrally formed.

15. The sexual aid of claim 11, wherein the securing feature is adjustable.

16. The sexual aid of claim 10, wherein the foot sleeve is formed from an elastic material.

17. The sexual aid of claim 10, wherein the foot sleeve generally defines a frustoconical shape.

18. The sexual aid of claim 10, wherein the foot sleeve has a length defined between the first and second openings, wherein the length is sized to expose a portion of the wearer's feet extended through the second open end of the foot sleeve.

19. The sexual aid of claim 11, wherein the foot sleeve and the securing feature are made from a natural or synthetic fiber.

20. A sexual aid comprising:
a foot sleeve having a first open end and a second open end, an internal space defined between the first open end and the second open end, the internal space being sized to receive portions of a wearer's two feet such that a portion of the wearer's feet extends past the second open end, the internal space being stretchable to receive at least a portion of a user's penis; and
a securing feature defining a loop, the loop extending from the first open end, the loop and foot sleeve being integrally formed, the loop being configured to wrap around back portions of the wearer's feet, over the wearer's toes, and around the foot sleeve.
